(19) United States
(12) Patent Application Publication
(10) Pub. No.: US 2016/0105790 A1
(43) Pub. Date: Apr. 14, 2016

(54) COMBINED LOCATION UPDATING PROCESSING METHOD, APPARATUS, AND SYSTEM

(71) Applicant: Huawei Technologies Co., Ltd., Shenzhen (CN)

(72) Inventor: Lin Shu, Shanghai (CN)

(21) Appl. No.: 14/974,386

(22) Filed: Dec. 18, 2015

Related U.S. Application Data
(63) Continuation of application No. PCT/CN2013/077454, filed on Jun. 19, 2013.

(51) Int. Cl. H04W 8/06; H04W 8/18; H04W 48/04

(52) U.S. Cl. CPC H04W 8/06; H04W 48/04; H04W 8/18

(57) ABSTRACT

A combined location updating processing method is provided, including: receiving, by a mobility management network element, a combined location updating request sent by user equipment; if the user equipment cannot access a current location area due to an area restriction or an access restriction, deleting, by the mobility management network element, all non-emergency bearer contexts of the user equipment, and reserving only an emergency bearer context of the user equipment; and sending, by the mobility management network element, a location updating accept message to the user equipment according to the combined location updating request, where the location updating accept message includes instruction information, and the instruction information is used for instructing the user equipment to enter a circuit switched domain detached state. In addition, other two combined location updating processing methods, and related apparatuses and systems are provided.

### CROSS-REFERENCE TO RELATED APPLICATIONS

This application is a continuation of International Application No. PCT/CN2013/077454, filed on Jun. 19, 2013, which is hereby incorporated by reference in its entirety.

### TECHNICAL FIELD

The present invention relates to the field of communications technologies, and in particular, to a combined location updating processing method, an apparatus, and a system.

### BACKGROUND

An evolved packet system (EPS) is a new generation network launched by the 3rd Generation Partnership Project (3GPP) based on existing second generation (2G) and third generation (3G) networks. The EPS network processes only packet switched (PS) services, but cannot process conventional circuit switched (CS) services (such as a voice service and a short message service). Because existing emergency communication services are all based on a conventional CS network, how to make the EPS network be capable of providing an emergency communication service is gradually becoming an issue that people are increasingly concerned about.

Based on the foregoing issue, a solution of providing an emergency service in a packet switched domain is proposed in the prior art; in this solution, the emergency service includes an emergency service initiated by user equipment (UE) in a normal service state and an emergency service initiated by user equipment in a restricted service state. The emergency service initiated by user equipment in a normal service state refers to that the user equipment camps on a normal serving cell and implements successful registration, and in this case, the user equipment may initiate an emergency packet data network (PDN) connection request process to establish an emergency PDN connection, and implement the emergency service by using the established emergency PDN connection; and the emergency service initiated by user equipment in a restricted service state refers to that the user equipment camps on a cell that provides restricted services, and in this case, the user equipment may initiate emergency attach, and establish an emergency PDN connection during the emergency attach, to implement the emergency service. According to a standard 3GPP definition of an emergency service, the emergency service may be initiated in both a normal service state and a restricted service state; however, a normal service can be initiated only in a normal service state.

In the prior art, there exists a typical scenario as follows: if in a normal serving cell, user equipment implements successful combined registration in a PS domain and a CS domain, and has established an emergency PDN connection, when the user equipment moves into a new TA that is not in a tracking area (TA) list, according to an existing tracking area updating (TAU) trigger condition, the user equipment initiates a combined TAU request, that is, a combined location updating request, to a mobility management entity (MME); although the MME learns that the user equipment is access-restricted or area-restricted in the new TA, the MME accepts the combined location updating request because the user equipment has established the emergency PDN connection currently, and initiates a deactivation process for normal (that is, non-emergency) EPS bearer contexts according to an initiation state of TAU; therefore, finally, the user equipment reserves only the emergency PDN connection and considers that the user equipment is emergency attached, that is, a PS domain status of the user equipment is in a restricted service state; meanwhile, the MME also considers that the user equipment is emergency attached, that is, the user equipment is in a restricted service state.

During study and practice of the prior art, the inventor of the present invention finds that, in the foregoing scenario, the user equipment may still initiate some signaling requests related to CS services, which not only causes unnecessary signaling overheads and a waste of resources on a network side, but also easily leads to misoperations on a user equipment side, and affects user experience.

### SUMMARY

Embodiments of the present invention provide a combined location updating processing method, an apparatus, and a system, which can reduce signaling overheads and save resources, avoid misoperations, and improve user experience when user equipment is emergency attached and enters a restricted service state.

According to a first aspect, an embodiment of the present invention provides a combined location updating processing method, including:

receiving, by a mobility management network element, a combined location updating request sent by user equipment;

if the user equipment cannot access a current location area due to an area restriction or an access restriction, deleting, by the mobility management network element, all non-emergency bearer contexts of the user equipment, and reserving only an emergency bearer context of the user equipment; and

sending, by the mobility management network element, a location updating accept message to the user equipment according to the combined location updating request, where the location updating accept message includes instruction information, and the instruction information is used for instructing the user equipment to enter a CS domain detached state.

In a first possible implementation manner, with reference to the first aspect, the location updating accept message further includes an updating result information element, and a result indicated by the updating result information element is location area updated, so that the user equipment learns, according to the updating result information element, that in the combined location updating request, only an updating request of a PS domain is accepted by the mobility management network element.

In a second possible implementation manner, with reference to the first possible implementation manner of the first aspect, that a result indicated by the updating result information element is location area updated, so that the user equipment learns, according to the updating result information element, that in the combined location updating request, only an updating request of a PS domain is accepted by the mobility management network element includes that:

if the mobility management network element is an MME, the result indicated by the updating result information element is TA updated, so that the user equipment learns, according to the updating result information element, that in the combined location updating request, only the updating request of the PS domain is accepted by the mobility management entity; or

if the mobility management network element is a serving GPRS support node (SGSN, where GPRS is General Packet Radio Service, that is, general packet radio service), the result indicated by the updating result information element is routing area updated (RAU), so that the user equipment learns, according to the updating result information element, that in the combined location updating request, only the updating request of the PS domain is accepted by the SGSN.

In a third possible implementation manner, with reference to the first aspect, that the user equipment cannot access a current location area due to an area restriction or an access restriction includes that:

the mobility management network element determines, according to configured area permission information, or access restriction information that is acquired from a home subscriber server (HSS)/home location register (HLR), that the user equipment cannot access the current location area.

In a fourth possible implementation manner, with reference to the first aspect or any one of the first to third possible implementation manners of the first aspect, before the sending, by the mobility management network element, a location updating accept message to the user equipment according to the combined location updating request, the method further includes:

initiating a detach process to a mobile switching center (MSC)/visitor location register (VLR), so as to detach the user equipment from a CS domain.

In a fifth possible implementation manner, with reference to the fourth possible implementation manner of the first aspect, before the initiating a detach process to an MSC/VLR, so as to detach the user equipment from a CS domain, the method further includes:

if an SGs interface association of the user equipment is not established between the mobility management network element and the MSC/VLR, initiating, by the mobility management network element, a location updating process to the MSC/VLR, so as to establish the SGs interface association of the user equipment.

According to a second aspect, an embodiment of the present invention further provides another combined location updating processing method, including:

sending, by user equipment, a combined location updating request to a mobility management network element;

receiving, by the user equipment, a location updating accept message returned by the mobility management network element, where the location updating accept message includes instruction information, the instruction information is used for instructing the user equipment to enter a CS domain detached state, and the instruction information is information that is sent by the mobility management network element after the mobility management network element receives the location updating request and when the user equipment cannot access a current location area due to an area restriction or an access restriction; and

entering, by the user equipment, the CS domain detached state according to the instruction information.

In a first possible implementation manner, with reference to the second aspect, the location updating accept message further includes an updating result information element, and if a result indicated by the updating result information element is location area updated, the method further includes:

learning, by the user equipment according to the updating result information element, that in the combined location updating request, only an updating request of a PS domain is accepted by the mobility management network element.

In a second possible implementation manner, with reference to the first possible implementation manner of the second aspect, that a result indicated by the updating result information element is location area updated includes that:

if the mobility management network element is an MME, the result indicated by the updating result information element is TA updated; or

if the mobility management network element is an SGSN, the result indicated by the updating result information element is RA updated.

In a third possible implementation manner, with reference to the second aspect, or the first or second possible implementation manner of the second aspect, the entering, by the user equipment, the CS domain detached state according to the instruction information includes:

setting, by the user equipment, a CS domain status to a detached state according to the instruction information.

In a fourth possible implementation manner, with reference to the third possible implementation manner of the second aspect, the method further includes:

deleting, by the user equipment according to the instruction information, all non-emergency bearer contexts, reserving only an emergency bearer context, and setting a PS domain status to a restricted service state.

According to a third aspect, an embodiment of the present invention further provides another combined location updating processing method, including:

sending, by user equipment, a combined location updating request to a mobility management network element;

if the user equipment deletes all non-emergency bearer contexts in a combined location updating process triggered by the combined location updating request, and reserves only an emergency bearer context, sending, by the user equipment, a detach request to the mobility management network element, where a detach type included in the detach request is international mobile subscriber identity (IMSI) detach; and

receiving, by the user equipment, a detach accept message sent by the mobility management network element, and entering a CS domain detached state according to the detach accept message.

In a first possible implementation manner, with reference to the third aspect, the entering a CS domain detached state according to the detach accept message includes:

setting a CS domain status to a detached state according to the detach accept message.

According to a fourth aspect, an embodiment of the present invention further provides a mobility management network element, including a receiving unit, a processing unit, and a sending unit, where

the receiving unit is configured to receive a combined location updating request sent by user equipment;

the processing unit is configured to: when it is determined that the user equipment cannot access a current location area due to an area restriction or an access restriction, delete all non-emergency bearer contexts of the user equipment, and reserve only an emergency bearer context of the user equipment; and

the sending unit is configured to send a location updating accept message to the user equipment according to the combined location updating request, where the location updating accept message includes instruction information, and the instruction information is used for instructing the user equipment to enter a CS domain detached state.

In a first possible implementation manner, with reference to the fourth aspect, the location updating accept message sent by the sending unit further includes an updating result information element, and a result indicated by the updating result information element is location area updated, so that the user equipment learns, according to the updating result information element, that in the combined location updating request, only an updating request of a PS domain is accepted by the mobility management network element.

In a second possible implementation manner, with reference to the fourth aspect, the processing unit is specifically configured to: when it is determined, according to configured area permission information, or access permission information that is acquired from an HSS/HLR, that the user equipment cannot access the current location area, delete all the non-emergency bearer contexts of the user equipment, and reserve only the emergency bearer context of the user equipment.

In a third possible implementation manner, with reference to the fourth aspect or the first or second possible implementation manner of the fourth aspect, the processing unit is further configured to initiate a detach process to an MSC/VLR, so as to detach the user equipment from a CS domain.

In a fourth possible implementation manner, with reference to the third possible implementation manner of the fourth aspect, the processing unit is further configured to: before initiating the detach process to the MSC/VLR, if an SGs interface association of the user equipment is not established between the MME and the MSC/VLR, initiate a location updating process to the MSC/VLR, so as to establish the SGs interface association of the user equipment.

According to a fifth aspect, an embodiment of the present invention further provides user equipment, including a sending unit, a receiving unit, and a processing unit, where

the sending unit is configured to send a combined location updating request to a mobility management network element;

the receiving unit is configured to receive a location updating accept message returned by the mobility management network element, where the location updating accept message includes instruction information, the instruction information is used for instructing the user equipment to enter a CS domain detached state, and the instruction information is information that is sent by the mobility management network element after the mobility management network element receives the location updating request and when the user equipment cannot access a current location area due to an area restriction or an access restriction; and

the processing unit is configured to enter the CS domain detached state according to the instruction information.

In a first possible implementation manner, with reference to the fifth aspect, the location updating accept message further includes an updating result information element, and if a result indicated by the updating result information element is location area updated,

the processing unit is further configured to learn, according to the updating result information element, that in the combined location updating request, only an updating request of a PS domain is accepted by the mobility management network element.

In a second possible implementation manner, with reference to the first possible implementation manner of the fifth aspect, the processing unit is specifically configured to set a CS domain status to a detached state according to the instruction information.

In a third possible implementation manner, with reference to the second possible implementation manner of the fifth aspect, the processing unit is further configured to: according to the instruction information, delete all non-emergency bearer contexts, reserve only an emergency bearer context, and set a PS domain status to a restricted service state.

According to a sixth aspect, an embodiment of the present invention further provides user equipment, including a first sending unit, a second sending unit, a receiving unit, and a processing unit, where

the first sending unit is configured to send a combined location updating request to a mobility management network element;

the second sending unit is configured to: when the user equipment deletes all non-emergency bearer contexts in a combined location updating process triggered by the combined location updating request, and reserves only an emergency bearer context, send a detach request to the mobility management network element, where a detach type included in the detach request is IMSI detach;

the receiving unit is configured to receive a detach accept message sent by the mobility management network element; and

the processing unit is configured to enter a CS domain detached state according to the detach accept message.

In a first possible implementation manner, with reference to the sixth aspect, the processing unit is specifically configured to set a CS domain status to a detached state according to the detach accept message.

According to a seventh aspect, an embodiment of the present invention further provides a communications system, including the mobility management network element or the user equipment provided by the embodiments of the present invention.

According to an eighth aspect, an embodiment of the present invention further provides a mobility management network element, including a processor, a transceiver device, and a memory that is configured to store data, where

the transceiver device is configured to receive a combined location updating request sent by user equipment, and send a location updating accept message to the user equipment according to the combined location updating request, where the location updating accept message includes instruction information, and the instruction information is used for instructing the user equipment to enter a CS domain detached state; and

the processor is configured to: when it is determined that the user equipment cannot access a current location area due to an area restriction or an access restriction, delete all non-emergency bearer contexts of the user equipment, and reserve only an emergency bearer context of the user equipment; and control the transceiver device to send the location updating accept message to the user equipment.

In a first possible implementation manner, with reference to the eighth aspect, the processor is further configured to initiate a detach process to a mobile switching center/visitor location register, so as to detach the user equipment from a CS domain.

In a second possible implementation manner, with reference to the eight aspect or the first possible implementation manner of the eighth aspect, the processor is further configured to: before initiating the CS domain detach process to the MSC/VLR, if an SGs interface association of the user equipment is not established between the MME and the MSC/VLR, initiate a location updating process to the MSC/VLR, so as to establish the SGs interface association of the user equipment.

According to a ninth aspect, an embodiment of the present invention further provides user equipment, including a processor, a transceiver device, and a memory that is configured to store data, where

the transceiver device is configured to send a combined location updating request to a mobility management network element, and receive a location updating accept message returned by the mobility management network element, where the location updating accept message includes instruction information, the instruction information is used for instructing the user equipment to enter a CS domain detached state, and the instruction information is information that is sent by the mobility management network element after the mobility management network element receives the location updating request and when the user equipment cannot access a current location area due to an area restriction or an access restriction; and

the processor is configured to enter the CS domain detached state according to the instruction information.

In a first possible implementation manner, with reference to the ninth aspect, the location updating accept message further includes an updating result information element, and if a result indicated by the updating result information element is location area updated,

the processor is further configured to learn, according to the updating result information element, that in the combined location updating request, only an updating request of a PS domain is accepted by the mobility management network element.

In a second possible implementation manner, with reference to the first possible implementation manner of the ninth aspect, the processor is further configured to: according to the instruction information, delete all non-emergency bearer contexts, reserve only an emergency bearer context, and set a PS domain status to a restricted service state.

According to a tenth aspect, an embodiment of the present invention further provides user equipment, including a processor, a transceiver device, and a memory that is configured to store data, where

the transceiver device is configured to send a combined location updating request to a mobility management network element, and send a detach request to the mobility management network element, where a detach type included in the detach request is IMSI detach; and receive a detach accept message sent by the mobility management network element; and

the processor is configured to control the transceiver device to send the combined location updating request to the mobility management network element, and when it is determined that the user equipment deletes all non-emergency bearer contexts in a combined location updating process triggered by the combined location updating request, and reserves only an emergency bearer context, control the transceiver device to send the detach request to the mobility management network element.

In the embodiments of the present invention, after receiving a combined location updating request sent by user equipment, if the user equipment cannot enter a current location area due to an area restriction or an access restriction, a mobility management network element deletes all non-emergency bearer contexts of the user equipment, and reserves only an emergency bearer context of the user equipment. A location updating accept message returned to the user equipment includes instruction information that is used for instructing the user equipment to enter a CS domain detached state, so that the user equipment may enter the CS domain detached state according to the instruction information after receiving the location updating accept message. Therefore, when the user equipment is emergency attached and enters a restricted service state, misoperations caused because the user equipment initiates an unnecessary signaling request are avoided, user experience is improved, signaling overheads on a network side are reduced, and resources are saved.

In addition, in another solution of the embodiments of the present invention, after user equipment sends a combined location updating request to a mobility management network element, if the user equipment deletes all non-emergency bearer contexts in a combined location updating process triggered by the combined location updating request, and reserves only an emergency bearer context, the user equipment sends a detach request in which a detach type is IMSI detach to the mobility management network element, and after receiving a detach accept message returned by the mobility management network element, the user equipment enters a CS domain detached state according to the detach accept message. Therefore, when the user equipment is emergency attached and enters a restricted service state, misoperations caused because the user equipment initiates an unnecessary signaling request are avoided, user experience is improved, signaling overheads on a network side are reduced, and resources are saved.

### BRIEF DESCRIPTION OF THE DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person skilled in the art may still derive other drawings from these accompanying drawings without creative efforts.

FIG. 1 is a flowchart of a combined location updating processing method according to Embodiment 1 of the present invention;

FIG. 2 is a flowchart of a combined location updating processing method according to Embodiment 2 of the present invention;

FIG. 3 is a flowchart of a combined location updating processing method according to Embodiment 3 of the present invention;

FIG. 4 is a flowchart of a combined location updating processing method according to Embodiment 4 of the present invention;

FIG. 5 is a flowchart of a combined location updating processing method according to Embodiment 5 of the present invention;

FIG. 6 is a flowchart of a combined location updating processing method according to Embodiment 6 of the present invention;

FIG. 7 is a schematic structural diagram of a mobility management network element according to an embodiment of the present invention;

FIG. 8 is a schematic structural diagram of user equipment according to an embodiment of the present invention; and

FIG. 9 is another schematic structural diagram of user equipment according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely some but not all of the embodiments of the present invention. All other embodiments obtained by a person skilled in the art based on the embodiments of the present invention without creative efforts shall fall within the protection scope of the present invention.

In the embodiments of the present invention, user equipment may be any one of the following, and the user equipment may be static or mobile. Static user equipment may include a terminal, a mobile station, a subscriber unit, a personal computer, a station, or the like. Mobile user equipment may include a cellular phone, a personal digital assistant (PDA), a wireless modem, a wireless communications device, a handheld device (Handheld), a laptop computer, a tablet computer, a cordless phone, a wireless local loop (WLL) station, or the like. The UE may be distributed in an entire wireless network.

In the embodiments of the present invention, a mobility management network element may be either of an MME or an SGSN. For ease of description, the MME is used as an example for description in the embodiments of the present invention. An MSC or a VLR in the embodiments of the present invention is usually set as one same network element in a combined manner, and is referred to as an MCS/VLR, or referred to as a VLR for short.

In the embodiments of the present invention, if the mobility management network element is an MME, a combined location updating process initiated by user equipment is a combined TAU process, or if the mobility management network element is an SGSN, a combined location updating process initiated by user equipment is a combined routing area updating (RAU) process. For ease of description, the combined TAU process is used as an example for description in the embodiments of the present invention.

To better describe the embodiments of the present invention, setting of an updating result information element in the combined TAU process is briefly described as follows:

For the combined TAU process initiated by the user equipment, the MME needs to set an updating result information element to inform the user equipment of updating result information. If the MME sets the updating result information element to “TA updated”, it means that a network side accepts only an updating request of a PS domain, and in this case, the MME needs a cause value to inform the user equipment of a reason why updating in a CS domain fails. In this way, after learning that the combined TAU process is successful only in the PS domain, the user equipment performs normal process processing according to the cause value, for example, starts a timer, and re-initiates a combined TAU process when the timer expires.

If the MME sets the updating result information element to “combined TA/location area (LA) updated”, it means that a network side accepts updating requests of both a PS domain and a CS domain; in this case, the user equipment considers that the user equipment successfully registers in the CS domain and can initiate normal CS services, including a CS fallback service and a short message service.

The embodiments of the present invention provide a combined location updating processing method, an apparatus, and a system, which are separately described in detail below.

### Embodiment 1

This embodiment of the present invention provides description from the perspective of a mobility management network element, where the mobility management network element may be specifically a device such as an MME or an SGSN.

A combined location updating processing method includes: receiving, by a mobility management network element, a combined location updating request sent by user equipment; if the user equipment cannot access a current location area due to an area restriction or an access restriction, deleting, by the mobility management network element, all non-emergency bearer contexts of the user equipment, and reserving only an emergency bearer context of the user equipment; and then, sending, by the mobility management network element, a location updating accept message to the user equipment according to the combined location updating request, where the location updating accept message includes instruction information, and the instruction information is used for instructing the user equipment to enter a CS domain detached state.

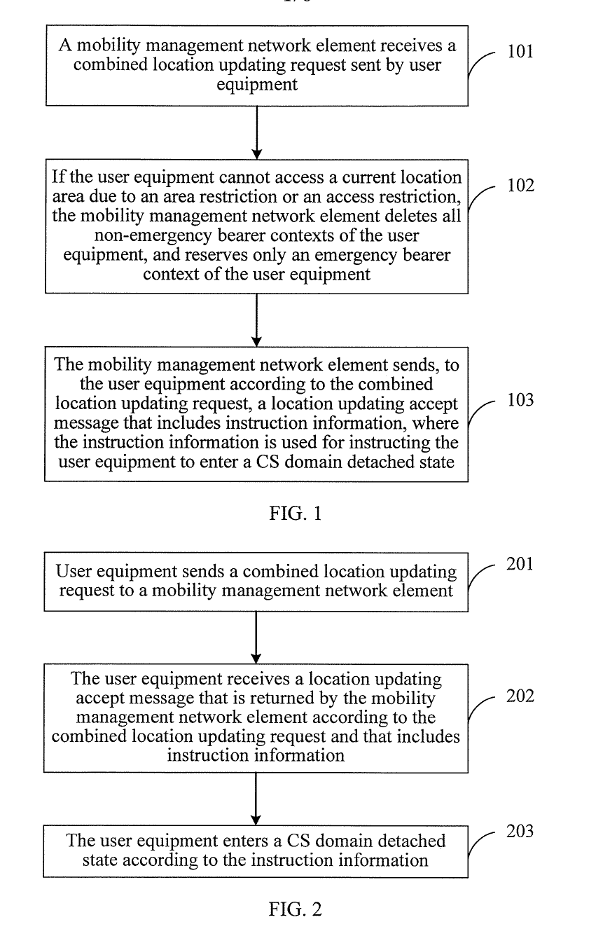

As shown in FIG. 1, a specific process may be as follows:

101: A mobility management network element receives a combined location updating request, such as a combined TAU request or a combined RAU request, sent by user equipment.

If combined registration of the user equipment is successful in a normal serving cell, and the user equipment establishes an emergency PDN connection, when the user equipment moves to a new location area, for example, to a new TA that is not in a TA list, according to an existing trigger condition of a combined location updating process, the user equipment initiates the combined location updating process, that is, send a location updating request message to the mobility management network element, for example, if the mobility management network element is an MME, an updating type included in the location updating request message is “combined TA/LA updating”, or if the mobility management network element is an SGSN, an updating type included in the location updating request message is “combined RA/LA updating”. Therefore, in this case, the mobility management network element may receive the combined location updating request sent by the user equipment.

102: If the user equipment cannot access a current location area due to an area restriction or an access restriction, the mobility management network element deletes all non-emergency bearer contexts of the user equipment, and reserves only an emergency bearer context of the user equipment.

The mobility management network element may determine, according to configured area permission information, or access restriction information that is acquired from a home subscriber server (HSS)/home location register (HLR), that the user equipment cannot access the current location area. It should be noted that, for user equipment that roams to a visited location network, that the user equipment cannot access a current location area means that the user equipment cannot roam in the current location area.

The area permission information may be specifically information that is configured by an operator on the mobility management network element and that indicates whether the user equipment is allowed to access a location area or some location areas. For example, if the mobility management network element is an MME, a TA or some TAs are configured to be inaccessible to the user equipment; or if the mobility management network element is an SGSN, an RA or some RAs are configured to be inaccessible to the user equipment.

The access restriction information may be specifically included in subscription data of the user equipment, and the mobility management network element acquires the subscription data of the user equipment from the HSS/HLR according to the received combined location updating request, where the subscription data includes information, about an access restriction in a network in which the MME is located, of the user equipment, for example: the user equipment is not allowed to access a universal mobile telecommunication system territorial radio access network (UTRAN), or the user equipment is not allowed to access an evolved universal mobile telecommunication system territorial radio access network (E-UTRAN).

For example, by using an example in which the mobility management network element is specifically an MME, if the user equipment enters a serving area of a new MME, the new MME may acquire context information of the user equipment from an original MME, and acquire subscription data of the user equipment from the HSS according to the acquired context information of the user equipment; however, if the user equipment is still located in a serving area of the original MME and the original MME saves the subscription data of the user equipment, the MME may directly use the saved subscription data; otherwise, if the user equipment is still located in a serving area of the original MME but the original MME does not save the subscription data of the user equipment, the original MME may directly acquire the subscription data of the user equipment from the HSS.

It should be noted that, although the user equipment is area-restricted or access-restricted in the current location area, because the user equipment has an emergency PDN connection currently, the mobility management network element still accepts the combined location updating request sent by the user equipment, and initiates a deactivation process for normal (that is, non-emergency) bearer contexts according to an initiation state of the combined location updating request, that is, deletes non-emergency bearer contexts. For example, by using an example in which the mobility management network element is specifically an MME, a specific process may be as follows:

If the combined location updating request is initiated by the user equipment in a connected state, the MME initiates an explicit bearer context deactivation process, so as to release all normal bearer contexts of the user equipment, that is, delete all non-emergency bearer contexts of the user equipment, so that the MME reserves only an emergency bearer context of the user equipment (for example, only an emergency PDN connection is reserved), considers that the user equipment is emergency attached, and sets a PS domain status of the user equipment to a restricted service state.

If the combined location updating request is initiated by the user equipment in an idle state, the MME may initiate a local deactivation process for bearer contexts, so as to release all normal bearer contexts of the user equipment, that is, delete all non-emergency bearer contexts of the user equipment, so that the MME reserves only an emergency bearer context of the user equipment (for example, only an emergency PDN connection is reserved), considers that the user equipment is emergency attached, and sets a PS domain status of the user equipment to a restricted service state.

103: The mobility management network element sends a location updating accept message to the user equipment according to the combined location updating request, where the location updating accept message includes instruction information, and the instruction information is used for instructing the user equipment to enter a CS domain detached state.

It should be noted that, the instruction information in this embodiment of the present invention is different from a “cause value” in the prior art, where the cause value merely indicates a reason why a combined location updating process fails in a CS domain, while the instruction information is used for instructing the user equipment to enter the CS domain detached state, that is, the instruction information not only indicates that all the non-emergency bearer contexts of the user equipment are deleted on a network side due to the area restriction or the access restriction, but also indicates that the user equipment is detached from a CS domain on the network side.

In addition, optionally, the location updating accept message may further include an updating result information element, and a result indicated by the updating result information element is location area updated, so that the user equipment learns, according to the updating result information element, that in the combined location updating request, only an updating request of a PS domain is accepted by the mobility management network element. Location area updating may be TAU, or may be routing area updating (RAU), and a specific process may be as follows:

if the mobility management network element is an MME, the result indicated by the updating result information element is TA updated, so that the user equipment learns, according to the updating result information element, that in the combined location updating request, only the updating request of the PS domain is accepted by the MME; or

if the mobility management network element is an SGSN, the result indicated by the updating result information element is RA updated, so that the user equipment learns, according to the updating result information element, that in the combined location updating request, only the updating request of the PS domain is accepted by the SGSN.

After learning that in the combined location updating request, only the updating request of the PS domain is accepted by the mobility management network element, the user equipment sets a CS domain status to a detached state according to the instruction information. After that, according to the instruction information, the user equipment may further delete all non-emergency bearer contexts, reserve only an emergency bearer context, and set a PS domain status to a restricted service state. For example, by using an example in which the mobility management network element is specifically an MME, a specific process may be as follows:

If the MME initiates the explicit bearer context deactivation process in step 102, bearer contexts are kept synchronized in real time on the user equipment and the network side, that is, in this case, the user equipment deletes all the non-emergency bearer contexts, so that the user equipment reserves only the emergency bearer context, for example, reserves only an emergency PDN connection, and the user equipment considers that the user equipment is emergency attached, and sets a PS domain status to a restricted service state, so that the bearer contexts can be kept synchronized between the user equipment and the network side.

If the MME initiates the local deactivation process for bearer contexts in step 102, after receiving the location updating accept message, the user equipment deactivates, according to the instruction information, bearer contexts that are locally deactivated on the network side, that is, deletes all the non-emergency bearer contexts, so that the user equipment reserves only the emergency bearer context, for example, reserves only an emergency PDN connection, and the user equipment considers that the user equipment is emergency attached, and sets a PS domain status to a restricted service state.

In addition, because the mobility management network element (such as an MME) considers that the user equipment is in a restricted service state, the mobility management network element rejects a CS service paging request delivered by an MSC/VLR to the user equipment, which leads to unnecessary signaling overheads between the mobility management network element and the MSC/VLR. Therefore, optionally, to further reduce signaling overheads on the network side, in addition to instructing the user equipment to be detached from the CS domain, the mobility management network element may further clear a CS domain registration context on the network side, so as to synchronize a CS registration status of the user equipment on the network side. Specifically, before sending the location updating accept message to the user equipment, the mobility management network element may proactively detach the user equipment from the CS domain on the network side, that is, before the step of “sending a location updating accept message to the user equipment” (that is, step 103), the mobility management network element may initiate a detach process to the MSC/VLR, so as to detach the user equipment from the CS domain.

Optionally, if an SGs interface association of the user equipment is not established between the mobility management network element and the MSC/VLR, for example, the mobility management network element changes, that is, the user equipment enters a serving area of a new mobility management network element, the mobility management network element may first establish an SGs interface association of the user equipment, and then initiate a CS domain detach process, that is, before initiating the detach process to the MSC/VLR, the method may further include:

if an SGs interface association of the user equipment is not established between the mobility management network element and the MSC/VLR, initiating a CS domain location updating process to the MSC/VLR, so as to establish the SGs interface association of the user equipment.

It should be noted that, if the mobility management network element does not change, that is, the user equipment is still in a serving area of an original mobility management network element, in this case, an SGs interface association of the user equipment is already established between the mobility management network element and the MSC/VLR, and therefore, the CS domain detach process may be initiated to the MSC/VLR directly.

It can be known from the foregoing that, in this embodiment, after receiving a combined location updating request sent by user equipment, if the user equipment cannot access a current location area due to an area restriction or an access restriction, a mobility management network element deletes all non-emergency bearer contexts of the user equipment, reserves only an emergency bearer context of the user equipment, and then adds, to a location updating accept message returned to the user equipment, instruction information used for instructing the user equipment to enter a CS domain detached state, so that after receiving the location updating accept message, the user equipment may enter the CS domain detached state according to the instruction information. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 2

This embodiment of the present invention provides description from the perspective of user equipment.

A combined location updating processing method includes: sending, by user equipment, a combined location updating request to a mobility management network element, and receiving a location updating accept message returned by the mobility management network element, where the location updating accept message includes instruction information, and the instruction information is used for instructing the user equipment to enter a CS domain detached state; and entering, by the user equipment, the CS domain detached state according to the instruction information. The instruction information is information that is sent by the mobility management network element after the mobility management network element receives the location updating request and when the user equipment cannot access a current location area due to an area restriction or an access restriction.

As shown in FIG. 2, a specific process may be as follows:

201: User equipment sends a combined location updating request, such as a combined TAU request or a combined RAU request, to a mobility management network element.

If combined registration of the user equipment is successful in a normal serving cell, and the user equipment establishes an emergency PDN connection, when the user equipment moves to a new location area, for example, to a new TA that is not in a TA list, according to an existing trigger condition of a combined location updating process, the user equipment initiates the combined location updating process, that is, send a location updating request message to the mobility management network element, if the mobility management network element is an MME, an updating type included in the location updating request message is “combined TA/LA updating”, or if the mobility management network element is an SGSN, an updating type included in the location updating request message is “combined RA/LA updating”. The mobility management network element may be specifically a device such as an MME or an SGSN.

202: The user equipment receives a location updating accept message that is returned by the mobility management network element according to the combined location updating request.

The location updating accept message includes instruction information, and the instruction information is used for instructing the user equipment to enter a CS domain detached state. The instruction information is information that is sent by the mobility management network element after the mobility management network element receives the location updating request and when the user equipment cannot access a current location area due to an area restriction or an access restriction.

In addition, optionally, the location updating accept message may further include an updating result information element, and if a result indicated by the updating result information element is location area updated, the method may further include:

learning, by the user equipment according to the updating result information element, that in the combined location updating request, only an updating request of a PS domain is accepted by the mobility management network element.

Location area updating may be TA updating, or may be RA updating, and a specific process may be as follows:

if the mobility management network element is an MME, the result indicated by the updating result information element is TA updated, so that the user equipment learns, according to the updating result information element, that in the combined location updating request, only the updating request of the PS domain is accepted by the MME; or

if the mobility management network element is an SGSN, the result indicated by the updating result information element is RA updated, so that the user equipment learns, according to the updating result information element, that in the combined location updating request, only the updating request of the PS domain is accepted by the SGSN.

The mobility management network element may delete all non-emergency bearer contexts of the user equipment, and reserve only an emergency bearer context of the user equipment. For a specific method, reference may be made to Embodiment 1, and details are not described herein again.

203: The user equipment enters a CS domain detached state according to the instruction information.

The user equipment may specifically set a CS domain status to a detached state according to the instruction information.

After that, according to the instruction information, the user equipment may further delete all the non-emergency bearer contexts, reserve only the emergency bearer context, and set a PS domain status to a restricted service state. For example, by using an example in which the mobility management network element is specifically an MME, a specific process may be as follows:

If the MME initiates an explicit bearer context deactivation process, bearer contexts are kept synchronized in real time on the user equipment and a network side, that is, in this case, the user equipment deletes all the non-emergency bearer contexts, so that the user equipment reserves only the emergency bearer context, for example, reserves only an emergency PDN connection, and the user equipment considers that the user equipment is emergency attached, and sets a PS domain status to a restricted service state, so that the bearer contexts can be kept synchronized between the user equipment and the network side.

If the MME initiates a local deactivation process for bearer contexts, after receiving the location updating accept message, the user equipment deactivates, according to the instruction information, bearer contexts that are locally deactivated on the network side, that is, deletes all the non-emergency bearer contexts, so that the user equipment reserves only the emergency bearer context, for example, reserves only an emergency PDN connection, and the user equipment considers that the user equipment is emergency attached, and sets a PS domain status to a restricted service state.

It can be known from the foregoing that, in this embodiment, after sending a combined location updating request, user equipment may receive a location updating accept message returned by a mobility management network element, where the location updating accept message includes instruction information used for instructing the user equipment to enter a CS domain detached state, so that the user equipment may enter the CS domain detached state according to the instruction information. Therefore, when the user equipment is emergency attached and enters a restricted service state, misoperations caused because the user equipment initiates an unnecessary signaling request are avoided, user experience is improved, signaling overheads on a network side are reduced, and resources are saved.

According to the methods described in Embodiment 1 and Embodiment 2, further detailed description will be provided in Embodiment 3 and Embodiment 4 below by using examples.

### Embodiment 3

In this embodiment, an example in which a mobility management network element is specifically an MME, an emergency bearer context is specifically a PDN connection, and the MME does not initiate a CS domain location updating process to an MSC/VLR is used for description.

Scenario: user equipment normally attaches to a normal serving cell in a combined manner, and has established several normal EPS bearers and an emergency PDN connection. In addition, an SGs interface association of the user equipment is established between the MME and the MSC/VLR.

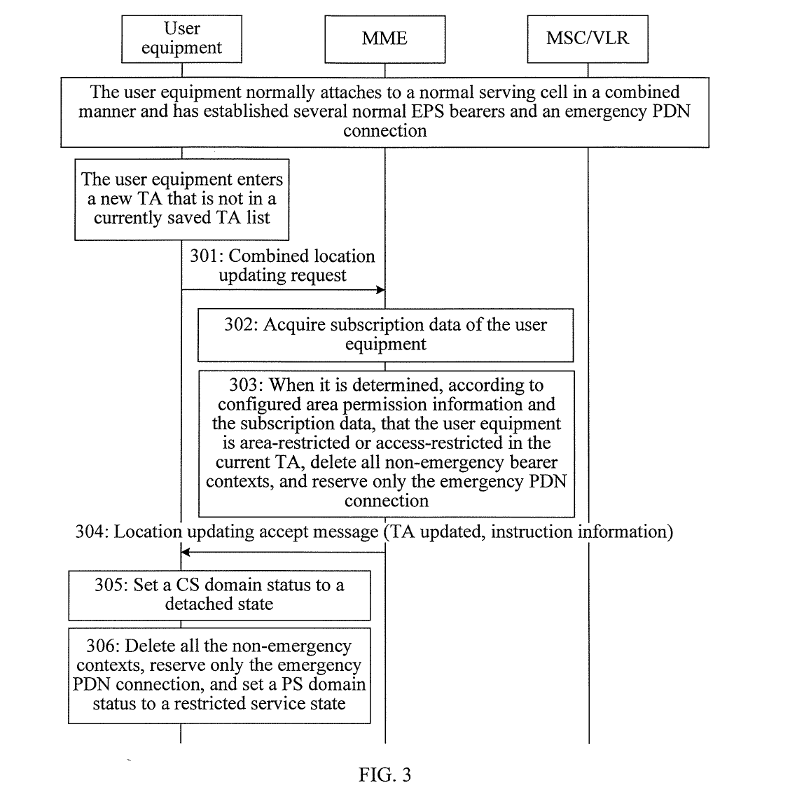

In this case, when the user equipment enters a new TA that is not in a currently saved TA list, according to an existing trigger condition of a combined location updating process, the user equipment initiates the combined location updating process. FIG. 3 shows a combined location updating processing method, and a specific process thereof may be as follows:

301: User equipment sends a combined location updating request to an MME.

302: After receiving the combined location updating request sent by the user equipment, the MME acquires subscription data of the user equipment according to the received combined location updating request.

For example, if the user equipment enters a serving area of a new MME, the new MME may acquire context information of the user equipment from an original MME, and acquire subscription data of the user equipment from an HSS according to the acquired context information of the user equipment; however, if the user equipment is still located in a serving area of the original MME and the original MME saves the subscription data of the user equipment, the MME may directly use the saved subscription data; otherwise, if the user equipment is still located in a serving area of the original MME but the original MME does not save the subscription data of the user equipment, the original MME may directly acquire the subscription data of the user equipment from the HSS.

303: When determining, according to area permission information configured on the MME and the acquired subscription data, that the user equipment is area-restricted or access-restricted in a current TA, the MME deletes all non-emergency bearer contexts of the user equipment, and reserves only an emergency PDN connection of the user equipment.

The area permission information configured on the MME may be specifically information that is configured by an operator on the MME and that indicates whether the user equipment is allowed to access a TA or some TAs.

The acquired subscription data may include information, about an access restriction in a network in which the MME is located, of the user equipment, for example, the user equipment is not allowed to access an E-UTRAN.

Further, if the combined location updating request is initiated by the user equipment in a connected state, the MME may initiate an explicit bearer context deactivation process, so as to release all normal bearer contexts of the user equipment, that is, delete all non-emergency bearer contexts of the user equipment, so that the MME reserves only the emergency PDN connection of the user equipment, considers that the user equipment is emergency attached, and sets a PS domain status of the user equipment to a restricted service state.

If the combined location updating request is initiated by the user equipment in an idle state, the MME may initiate a local deactivation process for bearer contexts, so as to release all normal bearer contexts of the user equipment, that is, delete all non-emergency bearer contexts of the user equipment, so that the MME reserves only the emergency PDN connection of the user equipment, considers that the user equipment is emergency attached, and sets a PS domain status of the user equipment to a restricted service state.

304: The MME sends a location updating accept message to the user equipment when completing a combined location updating process triggered by the combined location updating request.

The location updating accept message includes an updating result information element and instruction information, where a result indicated by the updating result information element is set to “TA updated”, and the instruction information is used for instructing the user equipment to enter a CS domain detached state.

305: The user equipment sets a CS domain status to a detached state according to instruction information, and does not initiate a normal CS service process subsequently, for example, does not initiate a circuit switched domain fallback (CS fallback) process.

306: According to the instruction information, the user equipment deletes all the non-emergency bearer contexts, reserves only the emergency PDN connection, and sets a PS domain status to a restricted service state, which may be specifically as follows:

If the MME initiates the explicit bearer context deactivation process, bearer contexts are kept synchronized in real time on the user equipment and a network side, that is, in this case, the user equipment deletes all the non-emergency bearer contexts, so that the user equipment reserves only the emergency PDN connection, and the user equipment considers that the user equipment is emergency attached, and sets a PS domain status to a restricted service state, so that the bearer contexts can be kept synchronized between the user equipment and the network side.

If the MME initiates the local deactivation process for bearer contexts, after receiving the location updating accept message, the user equipment deactivates, according to the instruction information, bearer contexts that are locally deactivated on the network side, that is, deletes all the non-emergency bearer contexts, so that the user equipment reserves only the emergency PDN connection, and the user equipment considers that the user equipment is emergency attached, and sets a PS domain status to a restricted service state.

It can be known from the foregoing that, in this embodiment, after an MME receives a combined location updating request sent by user equipment, if the user equipment cannot access a current location area due to an area restriction or an access restriction, the MME deletes all non-emergency bearer contexts of the user equipment, reserves only an emergency PDN connection of the user equipment, and then adds, to a location updating accept message returned by the MME to the user equipment, instruction information used for instructing the user equipment to enter a CS domain detached state, so that after receiving the location updating accept message, the user equipment may enter the CS domain detached state according to the instruction information. Therefore, when the user equipment is emergency attached and enters a restricted service state, misoperations caused because the user equipment initiates an unnecessary signaling request are avoided, signaling overheads are reduced, and resources are saved.

### Embodiment 4

In this embodiment, an example in which a mobility management network element is specifically an MME and an emergency bearer context is specifically a PDN connection is used for description, which is the same as Embodiment 3; in this embodiment, the MME needs to initiate a CS domain detach process to an MSC/VLR, which is different from Embodiment 3. Detailed descriptions are provided below.

Scenario: user equipment normally attaches to a normal serving cell in a combined manner, and has established several normal EPS bearers and an emergency PDN connection.

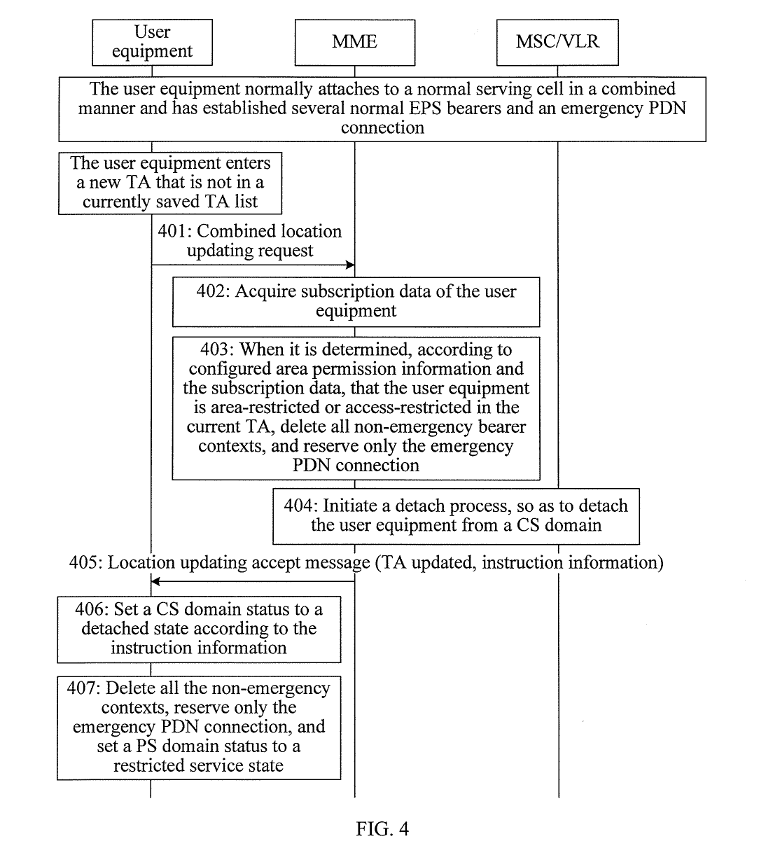

In this case, when the user equipment enters a new TA that is not in a currently saved TA list, according to an existing trigger condition of a combined location updating process, the user equipment initiates the combined location updating process. FIG. 4 shows a combined location updating processing method, and a specific process thereof may be as follows:

401: User equipment sends a combined location updating request to an MME.

402: After receiving the combined location updating request sent by the user equipment, the MME acquires subscription data of the user equipment according to the received combined location updating request.

For example, if the user equipment enters a serving area of a new MME, the new MME may acquire context information of the user equipment from an original MME, and acquire subscription data of the user equipment from an HSS according to the acquired context information of the user equipment; however, if the user equipment is still located in a serving area of the original MME and the original MME saves the subscription data of the user equipment, the MME may directly use the saved subscription data; otherwise, if the user equipment is still located in a serving area of the original MME but the original MME does not save the subscription data of the user equipment, the original MME may directly acquire the subscription data of the user equipment from the HSS.

403: When determining, according to area permission information configured on the MME and the acquired subscription data, that the user equipment is area-restricted or access-restricted in a current TA, the MME deletes all non-emergency bearer contexts of the user equipment, and reserves only an emergency PDN connection of the user equipment.

The area permission information configured on the MME may be specifically information that is configured by an operator on the MME and that indicates whether the user equipment is allowed to access a TA or some TAs.

The acquired subscription data may include information, about an access restriction in a network in which the MME is located, of the user equipment, for example, the user equipment is not allowed to access an E-UTRAN.

Further, if the combined location updating request is initiated by the user equipment in a connected state, the MME may initiate an explicit bearer context deactivation process, so as to release all normal bearer contexts of the user equipment, that is, delete all non-emergency bearer contexts of the user equipment, so that the MME reserves only the emergency PDN connection of the user equipment, considers that the user equipment is emergency attached, and sets a PS domain status of the user equipment to a restricted service state.

If the combined location updating request is initiated by the user equipment in an idle state, the MME may initiate a local deactivation process for bearer contexts, so as to release all normal bearer contexts of the user equipment, that is, delete all non-emergency bearer contexts of the user equipment, so that the MME reserves only the emergency PDN connection of the user equipment, considers that the user equipment is emergency attached, and sets a PS domain status of the user equipment to a restricted service state.

404: The MME initiates a detach process to an MSC/VLR, so as to detach the user equipment from a CS domain, which may be specifically as follows:

If an SGs interface association of the user equipment is not established between the MME and the MSC/VLR, a CS domain location updating process is initiated to the MSC/VLR, so as to establish the SGs interface association of the user equipment, and then the MME imitates the detach process to the MSC/VLR, so as to detach the user equipment from the CS domain.

If an SGs interface association of the user equipment is already established between the MME and the MSC/VLR, the MME directly initiates the detach process to the MSC/VLR, so as to detach the user equipment from the CS domain.

405: The MME sends a location updating accept message to the user equipment when completing a combined location updating process triggered by the combined location updating request.

The location updating accept message includes an updating result information element and instruction information, where a result indicated by the updating result information element is set to “TA updated”, and the instruction information is used for instructing the user equipment to enter a CS domain detached state.

406: The user equipment sets a CS domain status to a detached state according to instruction information, and does not initiate a normal CS service process subsequently, for example, does not initiate a circuit switched domain fallback (CS fallback) process.

407: According to the updating result information element and the instruction information, the user equipment deletes all the non-emergency bearer contexts, reserves only the emergency PDN connection, and sets a PS domain status to a restricted service state, which may be specifically as follows:

If the MME initiates the explicit bearer context deactivation process, bearer contexts are kept synchronized in real time on the user equipment and a network side, that is, in this case, the user equipment deletes all the non-emergency bearer contexts, so that the user equipment reserves only the emergency PDN connection, and the user equipment considers that the user equipment is emergency attached, and sets a PS domain status to a restricted service state, so that the bearer contexts can be kept synchronized between the user equipment and the network side.

If the MME initiates the local deactivation process for bearer contexts, after receiving the location updating accept message, the user equipment deactivates “bearer contexts that are locally deactivated on the network side” according to the instruction information, that is, deletes all the non-emergency bearer contexts, so that the user equipment reserves only the emergency PDN connection, and the user equipment considers that the user equipment is emergency attached, and sets a PS domain status to a restricted service state.

It can be known from the foregoing that, in this embodiment, after an MME receives a combined location updating request sent by user equipment, if the user equipment cannot access a current location area due to an area restriction or an access restriction, the MME deletes all non-emergency bearer contexts of the user equipment, reserves only an emergency PDN connection of the user equipment, and initiates a detach process to an MCS/VLR to detach the user equipment from a CS domain; and then adds, to a location updating accept message returned to the user equipment, instruction information used for instructing the user equipment to enter a CS domain detached state, so that after receiving the location updating accept message, the user equipment may enter the CS domain detached state according to the updating result information element and the instruction information. Therefore, when the user equipment is emergency attached and enters a restricted service state, misoperations caused because the user equipment initiates an unnecessary signaling request are avoided, signaling overheads are reduced, and resources are saved.

In the foregoing embodiment, detaching the user equipment from the CS domain is mainly implemented by the mobility management network element. Optionally, detaching the user equipment from the CS domain may also be implemented by a user equipment side, which will be described in Embodiment 5 and Embodiment 6 below.

### Embodiment 5

This embodiment of the present invention provides description from the perspective of user equipment.

A combined location updating processing method includes: sending, by user equipment, a combined location updating request to a mobility management network element; if the user equipment deletes all non-emergency bearer contexts in a combined location updating process triggered by the combined location updating request, and reserves only an emergency bearer context, sending, by the user equipment, a detach request to the mobility management network element, where a detach type included in the detach request is IMSI detach; and receiving, by the user equipment, a detach accept message sent by the mobility management network element, and entering a CS domain detached state according to the detach accept message.

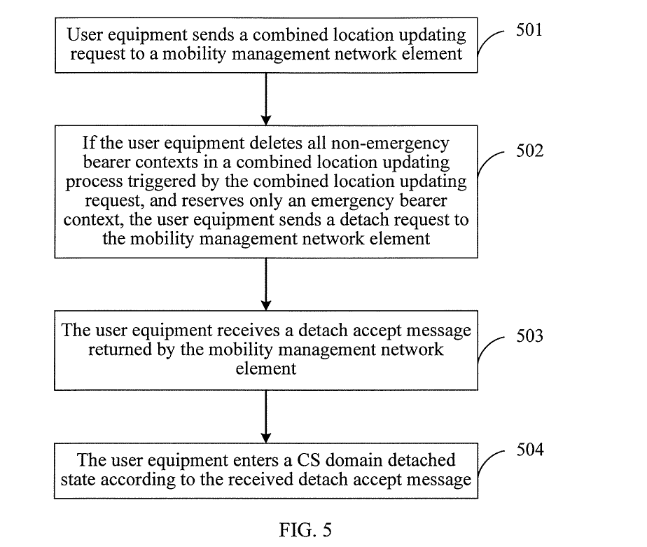

As shown in FIG. 5, a specific process may be as follows:

501: User equipment sends a combined location updating request, such as a combined TAU request or a combined RAU request, to a mobility management network element.

If combined registration of the user equipment is successful in a normal serving cell, and the user equipment establishes an emergency PDN connection, when the user equipment moves to a new location area, for example, to a new TA that is not in a TA list, according to an existing trigger condition of a combined location updating process, the user equipment initiates the combined location updating process, that is, send a location updating request message to the mobility management network element, if the mobility management network element is an MME, an updating type included in the location updating request message is “combined TA/LA updating”, or if the mobility management network element is an SGSN, an updating type included in the location updating request message is “combined RA/LA updating”. The mobility management network element may be specifically a device such as an MME or an SGSN.

502: If the user equipment deletes all non-emergency bearer contexts in a combined location updating process triggered by the combined location updating request, and reserves only an emergency bearer context, the user equipment sends a detach request to the mobility management network element.

Before sending the detach request, the user equipment may receive a location updating accept message that is returned by the mobility management network element according to the combined location updating request, where the location updating accept message includes an updating result information element, and a result indicated by the updating result information element may be “combined TA/LA updated”.

That “the user equipment deletes all non-emergency bearer contexts in a combined location updating process triggered by the combined location updating request, and reserves only an emergency bearer context” may be caused by a non-emergency bearer context deletion process that is triggered by the mobility management network element after the mobility management network element receives the combined location updating request and when the user equipment cannot access a current location area due to an area restriction or an access restriction, which may be specifically as follows:

If the mobility management network element initiates an explicit bearer context deactivation process, bearer contexts are kept synchronized in real time on the user equipment and a network side, that is, in this case, the user equipment deletes all the non-emergency bearer contexts, and reserves only the emergency bearer context, for example, reserves only an emergency PDN connection.

If the mobility management network element initiates a local deactivation process for bearer contexts, after receiving the location updating accept message, the user equipment deactivates, according to a bearer context status information element included in the location updating accept message, bearer contexts that are locally deactivated on the network side, that is, deletes all the non-emergency bearer contexts, and reserves only the emergency bearer context, for example, reserves only an emergency PDN connection.

The detach type included in the detach request is IMSI detach, that is, the detach type included in the detach request is set to “IMSI detach”. In this way, after receiving the detach request in which the detach type is “IMSI detach”, the mobility management network element, such as an MME, may perform a CS detach process, including initiating an explicit CS detach process to an MSC/VLR, to implement CS detach of the user equipment on the network side.

503: The user equipment receives a detach accept message returned by the mobility management network element.

After the user equipment implements CS detach on the network side, the mobility management network element (such as an MME) returns a detach accept message to the user equipment to notify the user equipment. In this case, the user equipment may receive the detach accept message returned by the mobility management network element (such as an MME).

504: The user equipment enters a CS domain detached state according to the received detach accept message, which may be specifically as follows:

The user equipment sets a CS domain status to a detached state according to the received detach accept message, and in this way, the user equipment does not initiate a normal CS service process subsequently, for example, the user equipment does not initiate a circuit switched domain fallback process.

It can be known from the foregoing that, in this embodiment, after user equipment sends a combined location updating request to a mobility management network element, if the user equipment deletes all non-emergency bearer contexts in a combined location updating process triggered by the combined location updating request, and reserves only an emergency bearer context, the user equipment sends a detach request in which a detach type is IMSI detach to the mobility management network element, and after receiving a detach accept message returned by the mobility management network element, the user equipment enters a CS domain detached state according to the detach accept message. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 6

According to the method described in Embodiment 5, further detailed description is provided in the following by using an example.

In this embodiment, an example in which a mobility management network element is specifically an MME, and an emergency bearer context is specifically a PDN connection is used for description.

Scenario: user equipment normally attaches to a normal serving cell in a combined manner, and has established several normal EPS bearers and an emergency PDN connection.

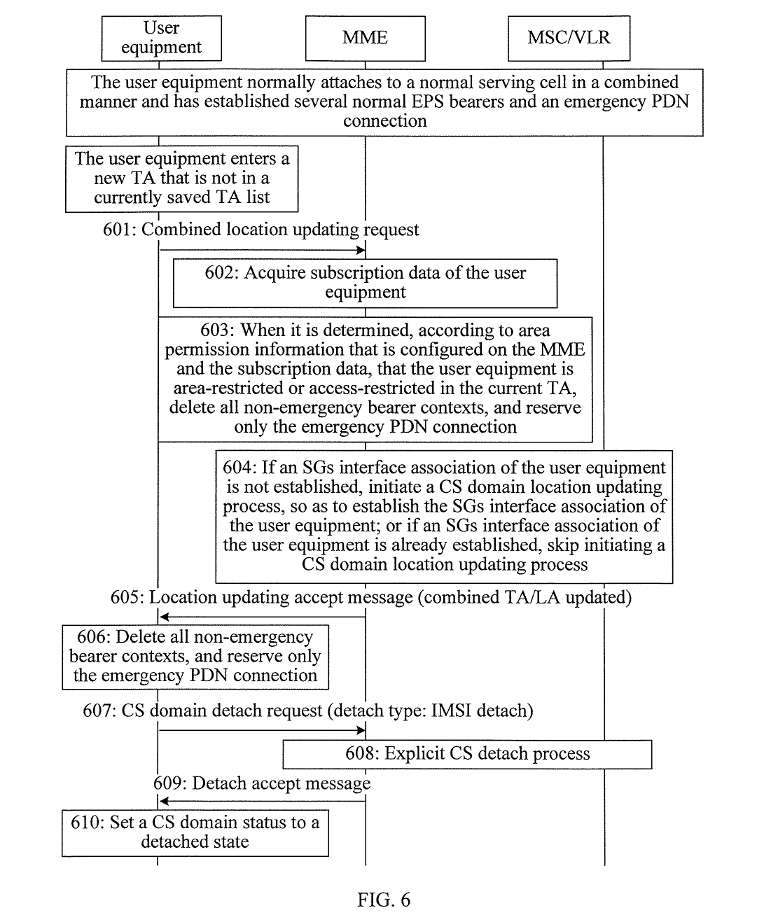

In this case, when the user equipment enters a new TA that is not in a currently saved TA list, according to an existing trigger condition of a combined location updating process, the user equipment initiates the combined location updating process. FIG. 6 shows a combined location updating processing method, and a specific process thereof may be as follows:

601: User equipment sends a combined location updating request to an MME.

602: After receiving the combined location updating request sent by the user equipment, the MME acquires subscription data of the user equipment according to the received combined location updating request.

For example, if the user equipment enters a serving area of a new MME, the new MME may acquire context information of the user equipment from an original MME, and acquire subscription data of the user equipment from an HSS according to the acquired context information of the user equipment; however, if the user equipment is still located in a serving area of the original MME and the original MME saves the subscription data of the user equipment, the MME may directly use the saved subscription data; otherwise, if the user equipment is still located in a serving area of the original MME but the original MME does not save the subscription data of the user equipment, the original MME may directly acquire the subscription data of the user equipment from the HSS.

603: When determining, according to area permission information configured on the MME and the acquired subscription data, that the user equipment is area-restricted or access-restricted in a current TA, the MME deletes all non-emergency bearer contexts of the user equipment, and reserves only an emergency PDN connection of the user equipment.

The area permission information configured on the MME may be specifically information that is configured by an operator on the MME and that indicates whether the user equipment is allowed to access a TA or some TAs.

The acquired subscription data may include information, about an access restriction in a network in which the MME is located, of the user equipment, for example, the user equipment is not allowed to access an E-UTRAN.

Further, if the combined location updating request is initiated by the user equipment in a connected state, the MME may initiate an explicit bearer context deactivation process, so as to release all normal bearer contexts of the user equipment, that is, delete all non-emergency bearer contexts of the user equipment, so that the MME reserves only the emergency PDN connection of the user equipment, considers that the user equipment is emergency attached, and sets a PS domain status of the user equipment to a restricted service state.

If the combined location updating request is initiated by the user equipment in an idle state, the MME may initiate a local deactivation process for bearer contexts, so as to release all normal bearer contexts of the user equipment, that is, delete all non-emergency bearer contexts of the user equipment, so that the MME reserves only the emergency PDN connection of the user equipment, considers that the user equipment is emergency attached, and sets a PS domain status of the user equipment to a restricted service state.

604: If an SGs interface association of the user equipment is not established between the MME and an MSC/VLR, the MME may initiate a CS domain location updating process to the MSC/VLR, so as to establish the SGs interface association of the user equipment; or if an SGs interface association of the user equipment is already established between the MME and an MSC/VLR, the MME may not initiate a CS domain location updating process to the MSC/VLR.

605: The MME sends a location updating accept message to the user equipment when completing a combined location updating process triggered by the combined location updating request.

The location updating accept message includes an updating result information element, where a result indicated by the updating result information element is set to “combined TA/LA updated”.

606: The user equipment deletes all the non-emergency bearer contexts, and reserves only the emergency PDN connection, which may be specifically as follows:

If the mobility management network element initiates the explicit bearer context deactivation process, bearer contexts are kept synchronized in real time on the user equipment and a network side, that is, in this case, the user equipment deletes all the non-emergency bearer contexts, and reserves only an emergency bearer context, for example, reserves only the emergency PDN connection.

If the mobility management network element initiates the local deactivation process for bearer contexts, after receiving the location updating accept message, the user equipment deactivates, according to a bearer context status information element included in the location updating accept message, bearer contexts that are locally deactivated on the network side, that is, deletes all the non-emergency bearer contexts, and reserves only an emergency bearer context, for example, reserves only the emergency PDN connection.

607: The user equipment sends a detach request to the MME, where a detach type included in the detach request message is “IMSI detach”.

608: After receiving the detach request in which the detach type is “IMSI detach”, the MME initiates a detach process to the MSC/VLR, so as to implement CS detach of the user equipment on a network side.

609: The MME returns a detach accept message to the user equipment.

610: After receiving the detach accept message returned by the MME, the user equipment sets a CS domain status to a detached state according to the received detach accept message, and in this way, the user equipment does not initiate a normal CS service process subsequently, for example, the user equipment does not initiate a circuit switched domain fallback process.

It can be known from the foregoing that, in this embodiment, after user equipment sends a combined location updating request to a mobility management network element, if the user equipment deletes all non-emergency bearer contexts in a combined location updating process triggered by the combined location updating request, and reserves only an emergency bearer context, the user equipment sends a detach request in which a detach type is IMSI detach to the mobility management network element, and after receiving a detach accept message returned by the mobility management network element, the user equipment enters a CS domain detached state according to the detach accept message. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 7

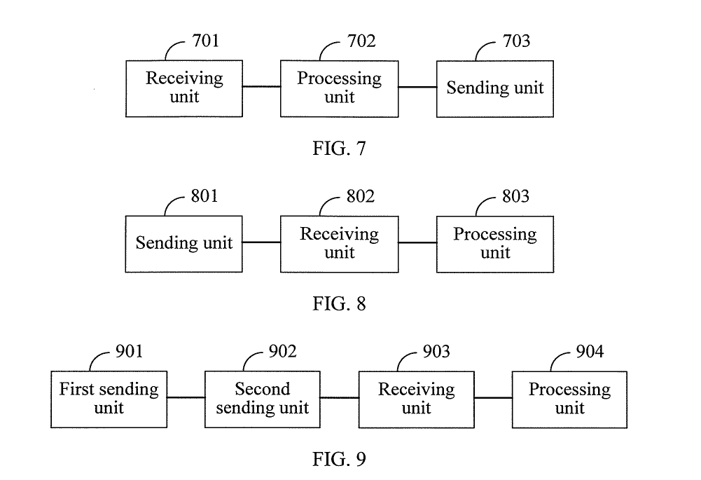

To better implement the foregoing methods, corresponding to Embodiment 1 to Embodiment 4, this embodiment of the present invention provides a mobility management network element. As shown in FIG. 7, the mobility management network element includes a receiving unit 701, a processing unit 702, and a sending unit 703.

The receiving unit 701 is configured to receive a combined location updating request, such as a combined TAU request or a combined RAU request, sent by user equipment.

The processing unit 702 is configured to: when it is determined that the user equipment cannot access a current location area due to an area restriction or an access restriction, delete all non-emergency bearer contexts of the user equipment, and reserve only an emergency bearer context of the user equipment.

The sending unit 703 is configured to send a location updating accept message to the user equipment according to the combined location updating request, where the location updating accept message includes instruction information, and the instruction information is used for instructing the user equipment to enter a CS domain detached state.

Optionally, the mobility management network element may determine, according to configured area permission information, or access restriction information that is acquired from an HSS or HLR, that the user equipment cannot access the current location area, that is:

the processing unit 702 may be specifically configured to: when it is determined, according to configured area permission information or access restriction information that is acquired from an HSS/HLR, that the user equipment cannot access the current location area, delete all the non-emergency bearer contexts of the user equipment, and reserve only the emergency bearer context of the user equipment.

The area permission information may be specifically information that is configured by an operator on the mobility management network element and that indicates whether the user equipment is allowed to access a location area or some location areas. For example, if the mobility management network element is an MME, a TA or some TAs are configured to be inaccessible to the user equipment; or if the mobility management network element is an SGSN, an RA or some RAs are configured to be inaccessible to the user equipment.

The access restriction information may be specifically included in subscription data of the user equipment, and the mobility management network element acquires the subscription data of the user equipment from the HSS/HLR according to the received combined location updating request, where the subscription data includes information, about an access restriction in a network in which the MME is located, of the user equipment, for example, the user equipment is not allowed to access a UTRAN, or the user equipment is not allowed to access an E-UTRAN.

For example, by using an example in which the mobility management network element is specifically an MME, if the user equipment enters a serving area of a new MME, a processing unit 702 of the new MME may acquire context information of the user equipment from an original MME, and acquire subscription data of the user equipment from the HSS according to the acquired context information of the user equipment; however, if the user equipment is still located in a serving area of the original MME and the original MME saves the subscription data of the user equipment, a processing unit 702 of the original MME may directly use the saved subscription data of the user equipment; otherwise, if the user equipment is still located in a serving area of the original MME but the original MME does not save the subscription data of the user equipment, a processing unit 702 of the original MME may directly acquire the subscription data of the user equipment from the HSS.

It should be noted that, although the processing unit 702 determines that the user equipment is area-restricted or access-restricted in the current location area, because the user equipment has an emergency PDN connection currently, the processing unit 702 still accepts the combined location updating request sent by the user equipment, and initiates a deactivation process for normal (that is, non-emergency) bearer contexts according to an initiation state of the combined location updating request, that is, deletes non-emergency bearer contexts, which may be specifically as follows:

If the combined location updating request is initiated by the user equipment in a connected state, the processing unit 702 initiates an explicit bearer context deactivation process, so as to release all normal bearer contexts of the user equipment, that is, delete all non-emergency bearer contexts of the user equipment, so that the mobility management network element reserves only an emergency bearer context of the user equipment (for example, only an emergency PDN connection is reserved), considers that the user equipment is emergency attached, and sets a PS domain status of the user equipment to a restricted service state.

If the combined location updating request is initiated by the user equipment in an idle state, the processing unit 702 may initiate a local deactivation process for bearer contexts, so as to release all normal bearer contexts of the user equipment, that is, delete all non-emergency bearer contexts of the user equipment, so that the mobility management network element reserves only an emergency bearer context of the user equipment (for example, only an emergency PDN connection is reserved), considers that the user equipment is emergency attached, and sets a PS domain status of the user equipment to a restricted service state.

Optionally, the location updating accept message sent by the sending unit 703 may further include an updating result information element, and a result indicated by the updating result information element is location area updated, so that the user equipment learns, according to the updating result information element, that in the combined location updating request, only an updating request of a PS domain is accepted by the mobility management network element. Location area updating may be TA updating, or may be RA updating, and a specific process may be as follows:

if the mobility management network element is an MME, the result indicated by the updating result information element is TA updated, so that the user equipment learns, according to the updating result information element, that in the combined location updating request, only the updating request of the PS domain is accepted by the MME; or

if the mobility management network element is an SGSN, the result indicated by the updating result information element is RA updated, so that the user equipment learns, according to the updating result information element, that in the combined location updating request, only the updating request of the PS domain is accepted by the SGSN.

In addition, because the mobility management network element (such as an ME) considers that the user equipment is in a restricted service state, the mobility management network element rejects a CS service paging request delivered by an MSC/VLR to the user equipment, which leads to unnecessary signaling overheads between the mobility management network element and the MSC/VLR. Therefore, optionally, to further reduce signaling overheads on a network side, in addition to instructing the user equipment to be detached from a CS domain, the mobility management network element may further clear a CS domain registration context on the network side, so as to synchronize a CS registration status of the user equipment on the network side. Specifically, before sending the location updating accept message to the user equipment, the mobility management network element may proactively detach the user equipment from the CS domain on the network side, that is:

the processing unit 702 may further be configured to initiate a detach process to the MSC/VLR, so as to detach the user equipment from the CS domain.

Optionally, if an SGs interface association of the user equipment is not established between the mobility management network element and the MSC/VLR, for example, the mobility management network element changes, that is, the user equipment enters a serving area of a new mobility management network element, the mobility management network element may first establish the SGs interface association of the user equipment, and then initiates a CS domain detach process, that is:

the processing unit 702 may further be configured to: before initiating the detach process to the MSC/VLR, if an SGs interface association of the user equipment is not established between the mobility management network element and the MSC/VLR, initiate a CS domain location updating process to the MSC/VLR, so as to establish the SGs interface association of the user equipment.

It should be noted that, if the mobility management network element does not change, that is, the user equipment is still in a serving area of an original mobility management network element, in this case, an SGs interface association of the user equipment is already established between the mobility management network element and the MSC/VLR, and therefore, the processing unit 702 may directly initiate the CS domain detach process directly.

The mobility management network element may be specifically an MME or an SGSN.

In specific implementation, the foregoing units may be implemented as independent entities, or may be combined randomly and implemented as a same entity or several entities. For specific implementation of the foregoing units, reference may be made to the foregoing method embodiments, and details are not described herein again.

It can be known from the foregoing that, in this embodiment, after a receiving unit 701 receives a combined location updating request sent by user equipment, if the user equipment cannot access a current location area due to an area restriction or an access restriction, a processing unit 702 deletes all non-emergency bearer contexts of the user equipment, reserves only an emergency bearer context of the user equipment, and then a sending unit 703 adds, to a location updating accept message returned to the user equipment, instruction information used for instructing the user equipment to enter a CS domain detached state, so that after receiving the location updating accept message, the user equipment may enter the CS domain detached state according to the instruction information. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 8

To better implement the foregoing methods, corresponding to Embodiment 1 to Embodiment 4, this embodiment of the present invention provides user equipment. As shown in FIG. 8, the user equipment includes a sending unit 801, a receiving unit 802, and a processing unit 803.

The sending unit 801 is configured to send a combined location updating request, such as a combined TAU request or a combined RAU request, to a mobility management network element.

The mobility management network element may be specifically a device such as an MME or an SGSN.

The receiving unit 802 is configured to receive a location updating accept message that is returned by the mobility management network element according to the combined location updating request.

The location updating accept message includes instruction information, and the instruction information is used for instructing the user equipment to enter a CS domain detached state. The instruction information is information that is sent by the mobility management network element after the mobility management network element receives the location updating request and when the user equipment cannot access a current location area due to an area restriction or an access restriction.

The processing unit 803 is configured to enter the CS domain detached state according to the instruction information.

The processing unit 803 may be specifically configured to set a CS domain status to a detached state according to the instruction information, and does not initiate a normal CS service process subsequently, for example, does not initiate a circuit switched domain fallback process.

After that, according to the instruction information, the user equipment may further delete all non-emergency bearer contexts, reserve only an emergency bearer context, and set a PS domain status to a restricted service state, that is:

the processing unit 803 is further configured to: according to the instruction information, delete all non-emergency bearer contexts, reserve only an emergency bearer context, and set a PS domain status to a restricted service state. For example, by using an example in which the mobility management network element is specifically an MME, a specific process may be as follows:

If the MME initiates an explicit bearer context deactivation process, bearer contexts are kept synchronized on the user equipment and a network side, that is, in this case, the processing unit 803 of the user equipment deletes all the non-emergency bearer contexts, so that the user equipment reserves only the emergency bearer context, for example, reserves only an emergency PDN connection, and the user equipment considers that the user equipment is emergency attached, and sets a PS domain status to a restricted service state, so that the bearer contexts can be kept synchronized between the user equipment and the network side.

If the MME initiates a local deactivation process for bearer contexts, after the user equipment receives the location updating accept message, the processing unit 803 may deactivate, according to the instruction information, bearer contexts that are locally deactivated on the network side, that is, deletes all the non-emergency bearer contexts, so that the user equipment reserves only the emergency bearer context, for example, reserves only an emergency PDN connection, and the user equipment considers that the user equipment is emergency attached, and sets a PS domain status to a restricted service state.

In addition, optionally, the location updating accept message received by the receiving unit 802 may further include an updating result information element, where a result indicated by the updating result information element is location area updated, that is:

the processing unit 803 is further configured to learn, according to the updating result information element, that in the combined location updating request, only an updating request of a PS domain is accepted by the mobility management network element.

Location area updating may be TA updating, or may be RA updating, and a specific process may be as follows:

if the mobility management network element is an MME, the result indicated by the updating result information element is TA updated, so that the processing unit 803 of the user equipment learns, according to the updating result information element, that in the combined location updating request, only the updating request of the PS domain is accepted by the MME; or

if the mobility management network element is an SGSN, the result indicated by the updating result information element is RA updated, so that the processing unit 803 of the user equipment learns, according to the updating result information element, that in the combined location updating request, only the updating request of the PS domain is accepted by the SGSN.

The mobility management network element may delete all the non-emergency bearer contexts of the user equipment, and reserve only the emergency bearer context of the user equipment. For a specific method, reference may be made to Embodiment 1, and details are not described herein again.

In specific implementation, the foregoing units may be implemented as independent entities, or may be combined randomly and implemented as a same entity or several entities. For specific implementation of the foregoing units, reference may be made to the foregoing method embodiments, and details are not described herein again.

It can be known from the foregoing that, in this embodiment, after a sending unit 801 of user equipment sends a combined location updating request, a receiving unit 802 may receive a location updating accept message returned by a mobility management network element, where the location updating accept message includes instruction information used for instructing the user equipment to enter a CS domain detached state, so that a processing unit 803 of the user equipment may enter the CS domain detached state according to the instruction information. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 9

To better implement the foregoing methods, corresponding to Embodiment 5 and Embodiment 6, this embodiment of the present invention provides another user equipment. As shown in FIG. 9, the user equipment includes a first sending unit 901, a second sending unit 902, a receiving unit 903, and a processing unit 904.

The first sending unit 901 is configured to send a combined location updating request, such as a combined TAU request or a combined RAU request, to a mobility management network element.

The mobility management network element may be specifically a device such as an MME or an SGSN.

The second sending unit 902 is configured to: when the user equipment deletes all non-emergency bearer contexts in a combined location updating process triggered by the combined location updating request, and reserves only an emergency bearer context, send a detach request to the mobility management network element.

That “the user equipment deletes all non-emergency bearer contexts in a combined location updating process triggered by the combined location updating request, and reserves only an emergency bearer context” may be caused by a non-emergency bearer context deletion process that is triggered by the mobility management network element after the mobility management network element receives the combined location updating request and when the user equipment cannot access a current location area due to an area restriction or an access restriction. For a specific method, reference may be made to the foregoing method embodiments, and details are not described herein again.

A detach type included in the detach request is IMSI detach, that is, the detach type included in the CS domain detach request is set to “IMSI detach”. In this way, after receiving the CS domain detach request in which the detach type is “IMSI detach”, the mobility management network element, such as an MME, may initiate a CS detach process, for example, initiate an explicit CS detach process to an MSC/VLR, to implement CS detach of the user equipment on a network side.

Specifically, the mobility management network element may delete all the non-emergency bearer contexts of the user equipment, and reserves only the emergency bearer context of the user equipment, or the user equipment may delete all the non-emergency bearer contexts, and reserves only the emergency bearer context. For a specific method of deleting, by the mobility management network element or the user equipment, the non-emergency bearer contexts, reference may be made to the foregoing embodiments, and details are not described herein again.

The receiving unit 903 is configured to receive a detach accept message sent by the mobility management network element.

Before the second sending unit 902 sends the detach request, the receiving unit 903 is further configured to receive a location updating accept message that is returned by the mobility management network element according to the combined location updating request, where the location updating accept message includes an updating result information element, and a result indicated by the updating result information element may be “combined TA/LA updated”.

The processing unit 904 is configured to enter a CS domain detached state according to the detach accept message.

Specifically, the processing unit 904 may set a CS domain status to a detached state according to the received detach accept message, and in this way, a normal CS service process is not initiated subsequently, for example, a circuit switched domain fallback process is not initiated.

In specific implementation, the foregoing units may be implemented as independent entities, or may be combined randomly and implemented as a same entity or several entities. For specific implementation of the foregoing units, reference may be made to the foregoing method embodiments, and details are not described herein again.

It can be known from the foregoing that, in this embodiment, after a first sending unit 901 of user equipment sends a combined location updating request to a mobility management network element, if the user equipment deletes all non-emergency bearer contexts in a combined location updating process triggered by the combined location updating request, and reserves only an emergency bearer context, a second sending unit 902 of the user equipment sends a detach request in which a detach type is IMSI detach to the mobility management network element, and after a receiving unit 903 receives a detach accept message returned by the mobility management network element, a processing unit 904 enters a CS domain detached state according to the detach accept message. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 10

Correspondingly, this embodiment of the present invention further provides a communications system, including any mobility management network element provided by the embodiments of the present invention, or the communications system includes any user equipment provided by the embodiments of the present invention. For details, reference may be made to the foregoing embodiments.

By using an example in which the communications system includes a first mobility management network element as an example, the communications system may be specifically as follows:

The first mobility management network element is configured to receive a combined location updating request sent by first user equipment; and when determining that the first user equipment cannot access a current location area due to an area restriction or an access restriction, delete all non-emergency bearer context of the first user equipment, and reserve only an emergency bearer context of the first user equipment, and send a location updating accept message to the first user equipment according to the combined location updating request, where the location updating accept message includes instruction information, and the instruction information is used for instructing the user equipment to enter a CS domain detached state. For details, reference may be made to the foregoing embodiments, and details are not described herein again.

Optionally, the first mobility management network element may be further configured to initiate a detach process to an MSC/VLR, so as to detach the first user equipment from a CS domain.

Optionally, the first mobility management network element may be further configured to initiate a CS domain location updating process to the MSC/VLR, so as to establish an SGs interface association of the first user equipment.

In addition, the communications system may further include the first user equipment, where the first user equipment is configured to send the combined location updating request to the first mobility management network element, and receive the location updating accept message returned by the first mobility management network element, where the location updating accept message includes instruction information, and the first user equipment enters a CS domain detached state according to the instruction information. For details, reference may be made to the foregoing embodiments, and details are not described herein again.

In the foregoing example, in the communications system, detaching the user equipment from the CS domain is mainly implemented by a network side; optionally, detaching the user equipment from the CS domain may also be implemented by a user equipment side, that the communications system may also be implemented in the following manner:

By using an example in which the communications system includes second user equipment, the communications system is specifically as follows:

The second user equipment is configured to send a combined location updating request to a second mobility management network element; if the second user equipment deletes all non-emergency bearer contexts in a combined location updating process triggered by the combined location updating request, and reserves only an emergency bearer context, send a detach request to the mobility management network element, where a detach type included in the detach request is IMSI detach; and receive a detach accept message sent by the second mobility management network element, and enter a CS domain detached state according to the detach accept message.

The detach type included in the detach request may be set to “IMSI detach”, and in this way, after receiving the detach request in which the detach type is “IMSI detach”, the second mobility management network element, such as an MME, may initiate a CS detach process, for example, initiate an explicit CS detach process to an MSC/VLR, so as to implement CS detach of the second user equipment on the network side. For details, reference may be made to the foregoing embodiments, and details are not described herein again.

In addition, the communications system may further include the second mobility management network element, where the second mobility management network element is configured to receive the combined location updating request sent by the second user equipment, and return a location updating accept message to the second user equipment; and receive the detach request that is sent by the second user equipment and in which the detach type is “IMSI detach”, and return the detach accept message to the second user equipment.

For specific implementation of the foregoing devices, reference may be made to the foregoing embodiments, and details are not described herein again.

Because the communications system includes any mobility management network element or any user equipment provided by the embodiments of the present invention, the communications system can achieve a beneficial effect the same as that of the foregoing mobility management network element or user equipment. For details, reference may be made to the foregoing embodiments, and details are not described herein again.

### Embodiment 11

Correspondingly, this embodiment of the present invention further provides a mobility management network element, including a processor, a transceiver device, and a memory that is configured to store data.

The transceiver device is configured to receive a combined location updating request sent by user equipment, and send a location updating accept message to the user equipment according to the combined location updating request, where the location updating accept message includes instruction information, and the instruction information is used for instructing the user equipment to enter a CS domain detached state.

The processor is configured to: when it is determined that the user equipment cannot access a current location area due to an area restriction or an access restriction, delete all non-emergency bearer contexts of the user equipment, and reserve only an emergency bearer context of the user equipment; and control the transceiver device to send the location updating accept message to the user equipment.

Optionally, the processor may be further configured to initiate a detach process to a mobile switching center/visitor location register, so as to detach the user equipment from a CS domain.

Optionally, the processor may be further configured to: before initiating the CS domain detach process to the MSC/VLR, if an SGs interface association of the user equipment is not established between the mobility management network element and the MSC/VLR, initiate a location updating process to the MSC/VLR, so as to establish the SGs interface association of the user equipment.

For specific implementation of the foregoing devices, reference may be made to the foregoing embodiments, and details are not described herein again.

It can be known from the foregoing that, in this embodiment, after a mobility management network element receives a combined location updating request sent by user equipment, if the user equipment cannot access a current location area due to an area restriction or an access restriction, the mobility management network element deletes all non-emergency bearer contexts of the user equipment, reserves only an emergency bearer context of the user equipment, and then adds, to a location updating accept message returned to the user equipment, instruction information used for instructing the user equipment to enter a CS domain detached state, so that after receiving the location updating accept message, the user equipment may enter the CS domain detached state according to the instruction information. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 12

Correspondingly, this embodiment of the present invention further provides user equipment, including a processor, a transceiver device, and a memory that is configured to store data.

The transceiver device is configured to send a combined location updating request to a mobility management network element, and receive a location updating accept message returned by the mobility management network element, where the location updating accept message includes instruction information, the instruction information is used for instructing the user equipment to enter a CS domain detached state, and the instruction information is information that is sent by the mobility management network element after the mobility management network element receives the location updating request and when the user equipment cannot access a current location area due to an area restriction or an access restriction.

The processor is configured to enter the CS domain detached state according to the instruction information.

Optionally, the location updating accept message may further include an updating result information element, and if a result indicated by the updating result information element is location area updated:

the processor may be further configured to learn, according to the updating result information element, that in the combined location updating request, only an updating request of a PS domain is accepted by the mobility management network element.

Optionally, the processor may be further configured to: according to the instruction information, delete all non-emergency bearer contexts, reserve only an emergency bearer context, and set a PS domain status to a restricted service state.

For specific implementation of the foregoing devices, reference may be made to the foregoing embodiments, and details are not described herein again.

It can be known from the foregoing that, in this embodiment, after sending a combined location updating request, user equipment may receive a location updating accept message returned by a mobility management network element, where the location updating accept message includes instruction information used for instructing the user equipment to enter a CS domain detached state, so that the user equipment may enter the CS domain detached state according to the instruction information. Therefore, when the user equipment is emergency attached and enters a restricted service state, misoperations caused because the user equipment initiates an unnecessary signaling request are avoided, user experience is improved, signaling overheads on a network side are reduced, and resources are saved.

### Embodiment 13

Correspondingly, this embodiment of the present invention further provides user equipment, including a processor, a transceiver device, and a memory that is configured to store data.

The transceiver device is configured to send a combined location updating request to a mobility management network element, and send a detach request to the mobility management network element, where a detach type included in the detach request is IMSI detach; and receive a detach accept message sent by the mobility management network element.

The processor is configured to control the transceiver device to send the combined location updating request to the mobility management network element, and when it is determined that the user equipment deletes all non-emergency bearer contexts in a combined location updating process triggered by the combined location updating request, and reserves only an emergency bearer context, control the transceiver device to send the detach request to the mobility management network element.

For specific implementation of the foregoing devices, reference may be made to the foregoing embodiments, and details are not described herein again.

It can be known from the foregoing that, in this embodiment, after user equipment sends a combined location updating request to a mobility management network element, if the user equipment deletes all non-emergency bearer contexts in a combined location updating process triggered by the combined location updating request, and reserves only an emergency bearer context, the user equipment sends a detach request in which a detach type is IMSI detach to the mobility management network element, and after receiving a detach accept message returned by the mobility management network element, enters a CS domain detached state according to the detach accept message. Therefore, when the user equipment is emergency attached and enters a restricted service state, misoperations caused because the user equipment initiates an unnecessary signaling request are avoided, user experience is improved, signaling overheads on a network side are reduced, and resources are saved.

A person of ordinary skill in the art may understand that all or some of the steps of the methods in the embodiments may be implemented by a program instructing related hardware. The program may be stored in a computer-readable storage medium. The storage medium may include: a read-only memory (ROM), a random access memory (RAM), a magnetic disk, or an optical disc.

The foregoing describes in detail a combined location updating processing method, an apparatus, and a system that are provided by the embodiments of the present invention. Specific examples are used in this specification to describe the principle and implementation manners of the present invention. The descriptions of the foregoing embodiments are merely intended to help understand the method and core idea of the present invention. In addition, a person skilled in the art may make, according to the idea of the present invention, modifications with respect to the specific implementation manners and the application scope. Therefore, the content of this specification shall not be construed as a limitation on the present invention.

What is claimed is:

1. A combined location updating processing method, comprising:
receiving, by a mobility management network element, a combined location updating request sent by user equipment;
if the user equipment cannot access a current location area due to an area restriction or an access restriction, deleting, by the mobility management network element, all non-emergency bearer contexts of the user equipment, and reserving only an emergency bearer context of the user equipment; and
sending, by the mobility management network element, a location updating accept message to the user equipment according to the combined location updating request, wherein the location updating accept message comprises instruction information, and the instruction information is used for instructing the user equipment to enter a circuit switched domain detached state.

2. The method according to claim 1, wherein:
the location updating accept message further comprises an updating result information element, and a result indicated by the updating result information element is location area updated, so that the user equipment learns, according to the updating result information element, that in the combined location updating request, only an updating request of a packet switched domain is accepted by the mobility management network element.

3. The method according to claim 2, wherein:
if the mobility management network element is a mobility management entity, the result indicated by the updating result information element is tracking area updated, so that the user equipment learns, according to the updating result information element, that in the combined location updating request, only the updating request of the packet switched domain is accepted by the mobility management entity; or
if the mobility management network element is a serving general packet radio service support node, the result indicated by the updating result information element is routing area updated, so that the user equipment learns, according to the updating result information element, that in the combined location updating request, only the updating request of the packet switched domain is accepted by the serving general packet radio service support node.

4. The method according to claim 1, wherein:
the mobility management network element determines, according to configured area permission information, or access restriction information that is acquired from a home subscriber server/home location register, that the user equipment cannot access the current location area.

5. The method according to claim 1, wherein before sending, by the mobility management network element, a location updating accept message to the user equipment according to the combined location updating request, the method further comprises:
initiating a detach process to a mobile switching center/visitor location register, so as to detach the user equipment from a circuit switched domain.

6. The method according to claim 5, wherein before initiating a detach process to a mobile switching center/visitor location register, so as to detach the user equipment from a circuit switched domain, the method further comprises:
if an SGs interface association of the user equipment is not established between the mobility management network element and the mobile switching center/visitor location register, initiating, by the mobility management network element, a location updating process to the mobile switching center/visitor location register, so as to establish the SGs interface association of the user equipment.

7. A mobility management network element, comprising:
a memory configured to store data;
a transceiver device configured to:
receive a combined location updating request sent by user equipment, and
send a location updating accept message to the user equipment according to the combined location updating request, wherein the location updating accept message comprises instruction information, and the instruction information is used for instructing the user equipment to enter a circuit switched domain detached state; and
a processor configured to:
when it is determined that the user equipment cannot access a current location area due to an area restriction or an access restriction, delete all non-emergency bearer contexts of the user equipment, and reserve only an emergency bearer context of the user equipment, and
control the transceiver device to send the location updating accept message to the user equipment.

8. The mobility management network element according to claim 7, wherein the processor is further configured to initiate a detach process to a mobile switching center/visitor location register, so as to detach the user equipment from a circuit switched domain.

9. The mobility management network element according to claim 7, wherein the processor is further configured to:
before initiating the circuit switched domain detach process to the mobile switching center/visitor location register, if an SGs interface association of the user equipment is not established between the mobility management entity and the mobile switching center/visitor location register, initiate a location updating process to the mobile switching center/visitor location register, so as to establish the SGs interface association of the user equipment.

10. User equipment, comprising:
a memory configured to store data;
a transceiver device configured to:
send a combined location updating request to a mobility management network element, and
receive a location updating accept message returned by the mobility management network element, wherein the location updating accept message comprises instruction information, the instruction information is used for instructing the user equipment to enter a circuit switched domain detached state, and the instruction information is information that is sent by the mobility management network element after the mobility management network element receives the location updating request and when the user equipment cannot access a current location area due to an area restriction or an access restriction; and
a processor is configured to enter the circuit switched domain detached state according to the instruction information.

11. The user equipment according to claim 10, wherein:
the location updating accept message further comprises an updating result information element; and
if a result indicated by the updating result information element is location area updated, the processor is further configured to learn, according to the updating result information element, that in the combined location updating request, only an updating request of a packet switched domain is accepted by the mobility management network element.

12. The user equipment according to claim 10, wherein the processor is further configured to:
according to the instruction information, delete all non-emergency bearer contexts, reserve only an emergency bearer context, and set a packet switched domain status to a restricted service state.
